(19) United States
(12) Patent Application Publication
(10) Pub. No.: US 2020/0302060 A1
(43) Pub. Date: Sep. 24, 2020

(54) ENABLING ACCESS TO CAPTURING DEVICES BY BASIC INPUT AND OUTPUT SYSTEMS (BIOS)

(71) Applicant: Hewlett-Packard Development Company, L.P., Spring, TX (US)

(72) Inventors: Pei-Yi Chiang, Taipei City (TW); Chung-Chun Chen, Taipei City (TW); Chao-An Chen, Taipei City (TW)

(73) Assignee: Hewlett-Packard Development Company, L.P., Spring, TX (US)

(21) Appl. No.: 16/648,684

(22) PCT Filed: Dec. 14, 2017
(86) PCT No.: PCT/US2017/066414

§ 371 Date: Mar. 19, 2020

(51) Int. Cl. G06F 21/57; G06F 21/32; G06F 21/60; G06F 21/78; G06F 9/54

(52) U.S. Cl. CPC G06F 21/572; G06F 21/32; G06F 9/542; G06F 21/78; G06F 21/604

(57) ABSTRACT

Examples techniques to enable access to a capturing device of a computing device by a basic input and output system (BIOS) of the computing device are described. In an example, an authentication parameter is obtained, in response to a request to access the capturing device. An access to the capturing device is enabled based on a verification of the authentication parameter.

### BACKGROUND

User devices, such as laptops and tablets, comprise devices to capture images, videos, and audio inputs. For example, a built-in camera of a computing system, such as webcam of a laptop, enables users to capture pictures or videos. In another example, a built-in microphone of the computing system allows users to record audio inputs.

Other than a user directly accessing the camera or microphone of the computing system, applications running on the computing system may also access the camera or microphone. For example, an application that provides video conferencing functionality to the user, when initiated, may activate the camera of the computing system. Simultaneously, the application also accesses the microphone of the computing device, which is generally used in conjunction with the camera, to capture audio inputs.

### BRIEF DESCRIPTION OF FIGURES

The following detailed description references the drawings, wherein:

FIG. 1 illustrates a computing device, in accordance with an example implementation of the present subject matter;

FIG. 2 illustrates a computing device, in accordance with another example implementation of the present subject matter;

FIG. 3 illustrates a BIOS of a computing device, in accordance with an example implementation of the present subject matter;

FIG. 4 illustrates a method for authorizing access to a capturing device of a computing device, according to an example of the present subject matter;

FIGS. 5A and 5B illustrate a method for authorizing access to a capturing device of a computing device, according to another example of the present subject matter; and

FIG. 6 illustrates a computing environment, according to an example implementation of the present subject matter.

### DETAILED DESCRIPTION

Computing devices, such as desktops, laptops, and tablets, generally include a camera and a microphone. An application running on a computing device may access the camera or microphone of the computing system to provide various functionalities. For instance, a voice over internet protocol (VOIP) application running on the computing device may access the microphone to allow a user to make a VOIP call; a social media application may access the camera for a user to capture and upload an image; and a video calling application may access the camera as well as the microphone for the user to participate in a video call. When such an application is launched by the user, the application initiates access to the camera, the microphone, or both to start capturing images, videos, or audio, as the case may be.

Generally, a computing device also connects to the internet, making it vulnerable to malware applications that may be installed on the computing device by malicious users who may then access the camera or microphone through the malware applications. Such an unauthorized access, without a user's knowledge, puts his privacy at stake.

In some cases, the computing device may comprise an LED indicator that indicates to the user that the camera is in use. However, generally, the malicious user may also interfere with the operating system (OS) of the computing device to control the LED indicator, such that the LED indicator does not indicate switching ON of the camera, even when the camera is switched ON.

Thus, generally, once the OS of the computing device is compromised, the camera and the microphone may be vulnerable to unauthorized accesses.

According to an example implementation of the present subject matter, techniques for authorizing access to a microphone or camera, referred to as a capturing device, of a computing device are described. The example methods and systems for authorizing the access provide for prevention of an access attempted without the knowledge of the user.

In an example implementation, when an application executing on the computing device requests access to the capturing device, the Basic Input and Output device (BIOS) of the computing device is notified. The BIOS then obtains an authentication parameter from a user to authorize the request to access the capturing device. The application is allowed to access the capturing device once the BIOS has verified the authentication parameter.

In an example, the authentication parameter, such as a fingerprint of the user or a password received from the user, is compared with an authorized authentication parameter stored in a secure memory component accessible to the BIOS to verify the authentication parameter. Verification of the authentication parameter by the BIOS to authorize the access to the capturing device prevents a malware application or a compromised OS from accessing the capturing device.

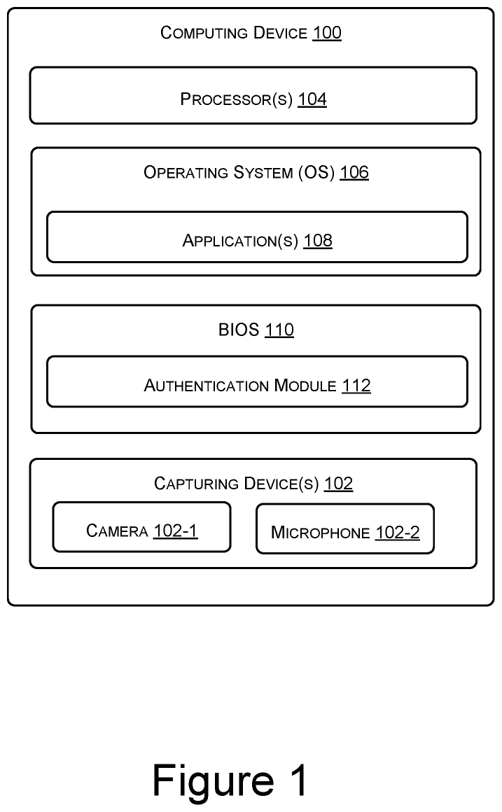

The above techniques are further described with reference to FIG. 1 to FIG. 6. It should be noted that the description and the Figures merely illustrate the principles of the present subject matter along with examples described herein and should not be construed as a limitation to the present subject matter. It is thus understood that various arrangements may be devised that, although not explicitly described or shown herein, embody the principles of the present subject matter. Moreover, all statements herein reciting principles, aspects, and implementations of the present subject matter, as well as specific examples thereof, are intended to encompass equivalents thereof.

FIG. 1 shows an example computing device 100, according to an example implementation of the present subject matter. Examples of the computing device 100 include, but are not limited to, electronic device, such as a desktop computer, a laptop, a smartphone, a personal digital assistant (PDAs), and a tablet that may include or may be interfaced with capturing device(s) 102. A capturing device 102 is a device to capture image, video, or audio inputs and includes, for example, a camera 102-1 and/or a microphone 102-2. The camera 102-1 and/or the microphone 102-2, interchangeably referred to as the capturing device 102, may be of various types.

One example of the capturing device 102 may be a camera 102-2 that is inbuilt or integrated into the computing device 100, such as a webcam. A webcam may be a complementary metal-oxide semiconductor (CMOS) camera in an example. Although not shown, in an example, the capturing device 102 also includes any external camera coupled to the computing device 100, such as an external webcam coupled to the computing device 100 through a universal serial bus (USB). Examples of the capturing device also include various internal or external microphones operable in conjunction with the computing device 100.

The computing device 100, among other things, includes processor(s) 104. The processor(s) 104 may be implemented as microprocessors, microcomputers, microcontrollers, digital signal processors, central processing units, state machines, logic circuitries, and/or any devices that manipulate signals based on operational instructions. Among other capabilities, the processor(s) 104 is configured to fetch and execute computer-readable instructions stored in memory (not shown in FIG. 1).

A processor 104 hosts an operating system (OS) 106 of the computing device 100. The OS 106 is a set of instructions that manages the hardware and software of the computing device 100 to enable the computing device 100 to provide various services to the users. In an example, the OS 106 executes application(s) 108 to provide various services to the user. An application 108 may be understood as a set of instructions to enable a functionality in the computing device 100. The application 108 may be either native to the OS 106 or may be a third-party application 108 installed on the OS 106. Examples of the application 108 include, but are not limited to, a VOIP application, video conferencing application, or a voice recorder application which can be executed by the OS 106 to provide functionalities, such as internet protocol (IP) based calling, video conferencing, and voice recording, respectively. The application 108, as mentioned above, may access the capturing device 102 to provide the corresponding functionalities.

The computing device 100 also includes a basic input and output system (BIOS) 110. The BIOS 110 performs hardware initialization to prepare the computing device 100 for use when the computing device 100 is booted up. The BIOS 110 also provides an interface between the input/output devices, storage drives, etc. (not shown) of the computing device 100 and the OS 106 during the boot up process. However, once the OS 106 is initialized, the OS 106 can communicate with the input/output devices directly. Examples of input/output devices include, but are not limited to, a mouse, keyboard, display, and the capturing device 102. To interface the input/output devices to the OS 106, an accessibility of each of the input/output devices may be defined in the BIOS 110. If an input/output device is defined to be disabled in the BIOS 110, the input/output device is not visible to the OS 106 and hence is not operable by the OS 106. In other words, an input/output device is accessible for the OS 106 upon being enabled by the BIOS 110.

In accordance with an example implementation of the present subject matter, by default, the BIOS 110 disables access of the capturing device 102 to the OS 106. In operation, when an application 108 requests access to the capturing device 102, an authentication module 112 of the BIOS 110 initiates a process to authorize the access. To authorize the access to the capturing device 102, the authentication module 112 obtains an authentication parameter and enables the application 108 to access the capturing device based on a verification of the authentication parameter.

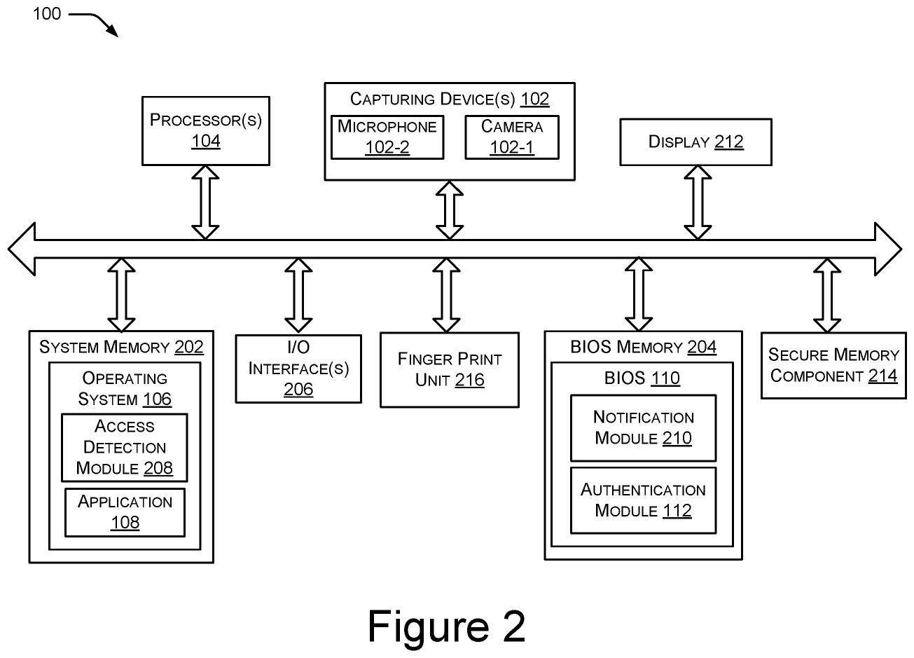

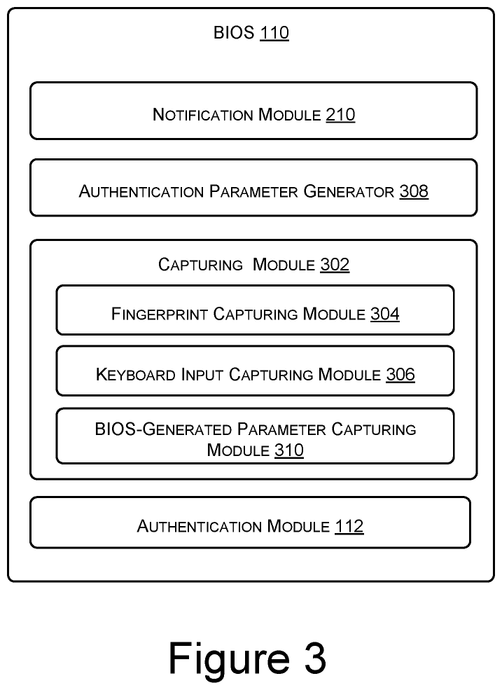

Failing authorization of the access by the BIOS 110, the access to the capturing device 102 by the application 108 continues to remain disabled. Authorization of the access to the capturing device 102 by the BIOS 110 provides for enhanced security in the computing device 100. Accordingly, unauthorized accesses by malware applications are prevented. Details relating to the process of authorizing the access implemented by the BIOS 110 are explained with reference to description of FIG. 2 and FIG. 3.

FIG. 2 illustrates the computing device 100, in accordance with another example implementation of the present subject matter. In an example implementation, the computing device 100 authentications the application 108 to access the capturing device 102.

As described earlier, the computing device 100 comprises the processor 104 to execute the OS 106, and as explained above, the processor 104 also executes the BIOS 110 to initialize OS 106.

The functions of the various elements shown in the Figures, including any functional blocks labelled as “processor(s)”, may be provided through the use of dedicated hardware as well as hardware capable of executing software. When provided by a processor, the functions may be provided by a single dedicated processor, by a single shared processor, or by a plurality of individual processors, some of which may be shared. Moreover, explicit use of the term “processor” should not be construed to refer exclusively to hardware capable of executing software, and may implicitly include, without limitation, digital signal processor (DSP) hardware, network processor, application specific integrated circuit (ASIC), field programmable gate array (FPGA), read only memory (ROM) for storing software, random access memory (RAM), non-volatile storage. Other hardware, conventional and/or custom, may also be included.

In the example implementation depicted in FIG. 2, the OS 106 of the computing device 102 resides in a system memory 202 and the BIOS 110 resides in a BIOS memory 204. However, other example implementations with the OS 106 and the BIOS 110 residing in the same memory component are also possible. The system memory 202 may include any computer-readable medium including, for example, volatile memory (e.g., RAM), and/or non-volatile memory (e.g., EPROM, flash memory, etc.). The BIOS memory 204 may be a ROM or a flash memory device addressable by the processor 104 at reset.

After a reset, the processor 104 performs a boot-up process for the OS 106 using the BIOS 110 as explained above. Once initialized, the OS 106 takes control of the various input/output devices of the computing device 100. Accordingly, the computing device 100 may also comprise an I/O interface 206 which enables the OS 106 to interface with the input/output devices. The I/O interface 206 may include a variety of software and hardware interfaces that allow the OS 106 to interact with the I/O devices. The I/O interface 206 also allows the OS 106 to interface with the capturing device 102.

In an example implementation of the present subject matter, the BIOS 110 authorizes the OS's 106 access to the capturing device 102 for preventing unauthorized capture of audio or visual inputs, for example, due to the OS 106 being compromised.

In an example, by default, the BIOS 110 disables access of the capturing device 102 by the OS. Accordingly, when the OS 106 is initialized after a reset, the control of the capturing device 102 is not assumed by the OS 106, and thus, no application 108 can directly access the capturing device 102. In an example, while maintaining the accessibility of the capturing device 102 by the OS 106 as ‘disabled’, the BIOS 110 may indicate the capturing device 102 to be available to the OS 106. In an example, the BIOS 110 may emulate the capturing device 102 that has been disabled to the OS 106. Accordingly, the OS 106 may not be able to communicate with the capturing device 102 that has been disabled but may detect the capturing device 102 to be present.

When an application 108, such as a video call application 108, which is to access the capturing device 102 for its operation, is launched, the application 108 requests the OS 106 provide access, for example, by way of a function call that the application 108 may make to the OS 106.

In accordance with an example implementation of the present subject matter, an access detection module 208 is implemented in the OS 106 to detect the request of the application 108 to access the capturing device 102. In an example, the access detection module 208 may register the function call to the OS 106 made by the application 108. Upon detecting the request to access the capturing device 102, the access detection module 208 notifies the BIOS 110 of the computing device 100.

Once the BIOS 110 is notified of the request of the application 108, in an example, a notification module 210 of the BIOS 110 generates a notification to notify a user of the request to access the capturing device 102. Such a notification allows the user to be aware of the capturing device 102 recording the audio or visual inputs. The notification may be displayed on a display 212 of the computing device 100. For the purpose, the notification module 210 of the BIOS 110 may communicate with the display 212 through the I/O interface 206.

Also, once the BIOS 110 is notified of the request of the application 108, in an example, the authentication module 112 is triggered to obtain the authentication parameter. In an example implementation, the authentication module 112 verifies the obtained authentication parameter based on an authorized authentication parameter stored in a secure memory component 214 of the computing device 100 accessible to the BIOS 110. Based on the obtained authentication parameter being verified, the application 108 is enabled to access the capturing device 102. Although not depicted in the example implementation illustrated in FIG. 2, the secure memory component 214 of the computing device 100 may be located in the BIOS memory 204 in one example.

In an example implementation, the authentication parameter may be a fingerprint of the user. Accordingly, the computing device 100 may include a fingerprint unit 216 coupled to the BIOS 110. For example, based on the notification regarding the request to access the capturing device 102 being displayed on the display 212, the user may provide his fingerprint input to the fingerprint unit 216. The authentication module 112 obtains the fingerprint input and verifies the same based on the process explained below in conjunction with FIG. 3 for authorizing the access.

FIG. 3 illustrates the BIOS 110 according to an example illustration of the present subject matter. As explained previously, when an application 108 requests access to the capturing device, the BIOS 110 is notified of the same. The notification regarding an application's request to access the capturing device 102 is received by the notification module 210 of the BIOS 110 that in turn notifies the user. The notification regarding an application's 108 request also triggers the authentication module 112 to authorize the access.

Accordingly, in one example, the authentication module 112 causes the notification module 210 to generate a prompt for the user to input the authentication parameter. The prompt may indicate to a user, an authentication parameter that the user may provide. For instance, the prompt may suggest that the user input a password or provide his fingerprint. In an example, the prompt may be displayed on the display 212 of the computing device 100. In another example, another output device, such as a speaker of the computing device 100, may provide the prompt. Accordingly, the notification module 210 may cause output of a preconfigured message, such as ‘enter password’ or ‘enter fingerprint’ on an output device (not shown) of the computing device 100.

The authentication parameter, provided by the user in response to the prompt, is received by a capturing module 302 of the BIOS 110. The capturing module 302 may include various types of capturing modules 302 corresponding to the different types of authentication parameters that may be used for authorizing access to the capturing device 102. In an example, as mentioned above, a fingerprint of the user may be an authentication parameter. Accordingly, a fingerprint capturing module 304 may be implemented within the capturing module 102. In another example in which the authentication parameter is a password, the capturing modules 302 may include a keyboard input capturing module 306. As will be understood, either the fingerprint capturing module 304, the keyboard input capturing module 306 or both may be implemented in the BIOS 110 depending on the authentication parameters that may be acceptable by the computing device 100 for authorizing access to the capturing device 102.

Thus, in an example, if a fingerprint is provided by the user as an authentication parameter, the fingerprint capturing module 304 receives the fingerprint of the user. In another example scenario where the computing device 100 is to authorize access to the capturing device 102 based on authentication parameters that are passwords, a password entered by the user is captured by the keyboard input capturing module 306. Thereafter, the authentication parameter, i.e., the fingerprint or the password captured by the fingerprint capturing module 304 or the keyboard input capturing module 306, or both, as the case may be, is provided to the authentication module 112 that verifies the authentication parameter provided by the user.

In an example, the authentication module 112 verifies the authentication parameter based on an authorized authentication parameter. The authorized authentication parameter may be stored in the BIOS memory 204 or the secure memory component 214 accessible to the BIOS 110, for instance. The authentication module 112 may compare the authentication parameter to the authorised authentication parameter stored in the secure memory component 214 for the verification.

Accordingly, in various example implementations of the present subject matter, the BIOS 110 may perform a registration process to register an authorised authentication parameter corresponding to a user of the computing device 100. For registering the authorised authentication parameter, the BIOS 110 may receive a user input corresponding to the authorised authentication parameter from the user and store the same in the secure memory component 214.

In an example, a user can register a password with the BIOS 110. For registering a password, the user provides the password, for example, via the keyboard (not shown), which is received and saved by the BIOS 110 as the authorised authentication parameter for use during authorization process. For instance, the authorised authentication parameter may be saved in the secure memory component 214.

Similarly, a fingerprint may also be registered with the BIOS 110 as the authorised authentication parameter. Registration of the fingerprint may involve the use of the previously mentioned fingerprint unit 216 coupled to the BIOS 110. During registration, the user may provide his fingerprint input to the fingerprint unit 216, for example, through a fingerprint scanner (not shown) of the fingerprint unit 216. The fingerprint input, thus registered, may be saved, for example, in the secure memory component 214. During authorization process, the BIOS 110 uses this saved fingerprint input to verify the fingerprint provided by the user. In an example, fingerprint inputs of more than one finger may be registered.

In yet another example implementation of the present subject matter, one of the types of authentication parameters that may be used by the computing device 100 for authorizing access to the capturing device 102 may be BIOS-generated authentication parameters. In such example implementations, when an application 108 requests access to the capturing device 102, the BIOS 110 may generate an authentication parameter that may be used for authorizing the access to the capturing device 102. Accordingly, in an example, the BIOS 110 comprises an authentication parameter generator 308 that generates the authentication parameter. In an example, the authentication parameter generator 308 incorporated in the BIOS 110, may be a random sequence generator that generates a sequence of characters, digits, or symbols.

The authentication parameter, i.e., the random sequence of characters, digits, or symbols, generated by the BIOS 110 may be displayed on the display 212. For the purpose, the authentication parameter generator 308 may cause the notification module 210 to interface with the display 110. Consequently, in example implementations where the BIOS-generated authentication parameters may be used by the computing device 100 for authorizing access to the capturing device 102, the prompt may also comprise the authentication parameter generated by the BIOS 110. The user may input the displayed authentication parameter, for example, by typing the same on a keyboard of the computing device 100. Further, in example implementations where the BIOS-generated authentication parameters may be used, the various types of capturing modules 302 explained above may include a BIOS-generated parameter capturing module 310.

Accordingly, in operation, in an example implementation when the prompt comprising a BIOS-generated authentication parameter is generated and displayed by the BIOS 110, the user may provide the same as an authentication parameter. Thereupon, the authentication parameter entered by the user is captured by the BIOS-generated parameter capturing module 310 and is provided to the authentication module 112 for verification.

The authentication module 112 verifies if the authentication parameter entered by the user is same as that generated by the authentication parameter generator. If the authentication parameter entered by the user matches the BIOS-generated authentication parameter, the authorization process is successful and the authentication module 112 allows the application to access the capturing device 102 of the computing device 100.

Similarly, in another example implementation where the BIOS-generated authentication parameters may be used for authorizing access to the capturing device 102, the authentication parameter may comprise a list of characters, symbols, images and so on. The BIOS 110 may generate and display the list of characters, symbols, or images. The user may be prompted to select, for example, using a mouse or a joystick of the computing device 100, one of the displayed characters, symbols, or images having a certain feature and upon successful selection by the user, the access to the capturing device may be enabled. To illustrate with an example, the BIOS-generated authentication parameter may be an image comprising several circles of various colours. For the authentication, the user may be prompted to hover a mouse of the computing device 100 over a ‘blue’ coloured circle from amongst the several circles displayed.

In an example implementation of the present subject matter, when an application 108 terminates an ongoing session of access to the capturing device 102, the application 108 indicates the same to the OS 106. The access detection module 208 of the OS 106 detects the termination of access and notifies the BIOS 110. The BIOS 110 thereafter disables the access of the OS 106 to the capturing device 102.

As apparent from the foregoing description of the present subject matter, applications 108 residing on the OS 106 of the computing device 100 are disallowed to access the capturing device 102 without the BIOS 110 authorizing the access. For example, when a malware application residing in the OS 106 of the computing device 102 requests access to the capturing device 102, the BIOS 110 notifies the user of the request while continuing to maintain the accessibility of the capturing device 102 by the OS 106 as ‘disabled’, by default. When the user knows that the request is not raised further to an action taken by him, the user may not provide the authentication parameter, and thus, the request to access is not authorized, thus denying the malware application the access to the capturing device 102.

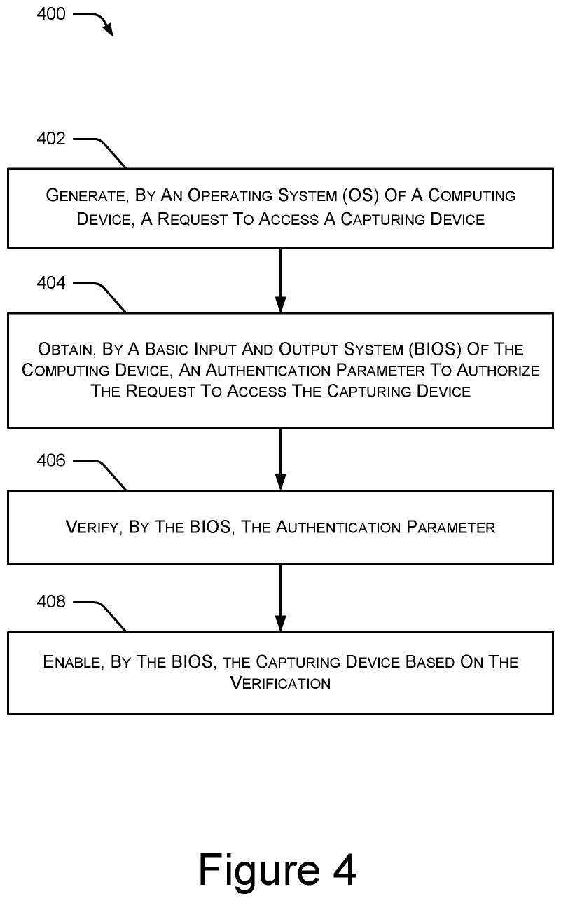

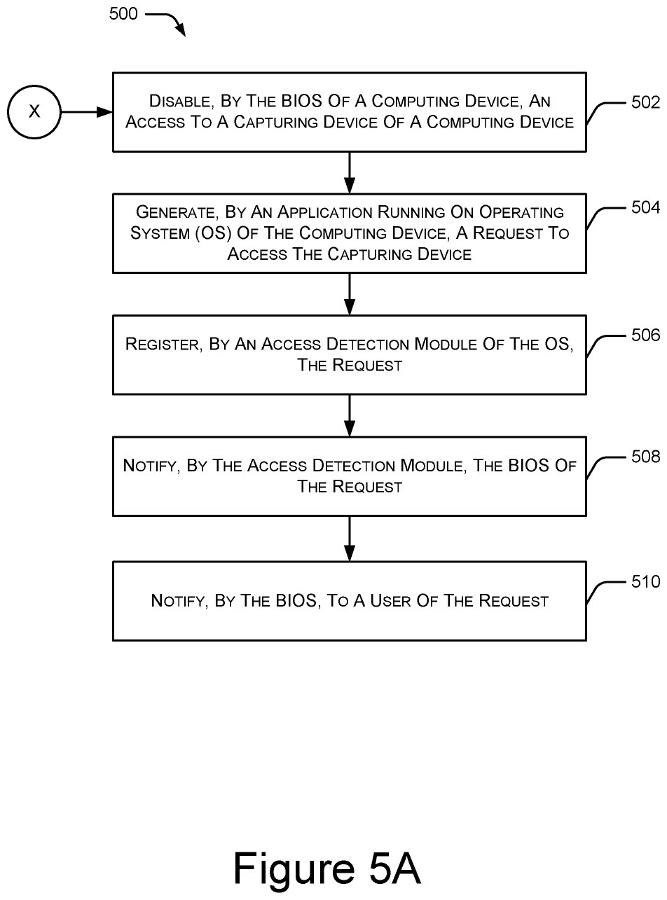

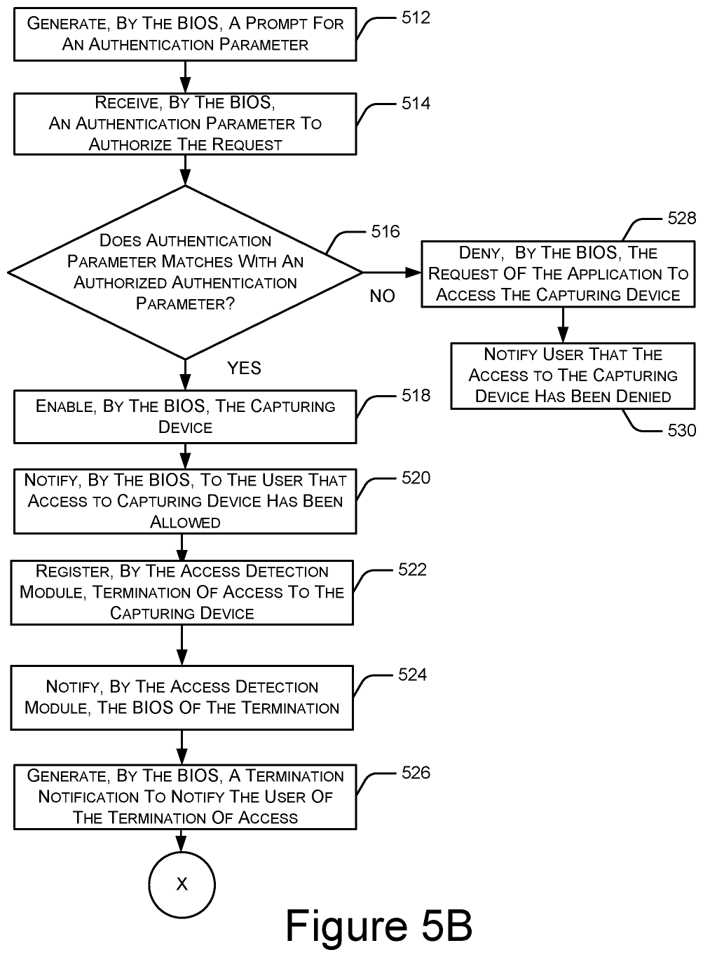

FIG. 4 illustrates a method 400 for authorization of an access to a capturing device of a computing device, according to an example implementation of the present subject matter. Similarly, FIGS. 5A and 5B illustrate a method 500 for authorizing access to a capturing device of a computing device, according to another example implementation of the present subject matter. Although the methods 400 and 500 may be implemented in a variety of electronic devices, for the ease of explanation, the present description of the example methods 400 and 500 to authorize access to a capturing device is provided in reference to the above-described computing device 100.

The order in which the methods 400 and 500 are described is not intended to be construed as a limitation, and any number of the described method blocks may be combined in any order to implement the methods 400 and 500, or an alternative method. Furthermore, the methods 400 and 500 may be implemented by processor(s) or computing device(s) through any suitable hardware, non-transitory machine readable instructions, or combination thereof.

It may be understood that blocks of the methods 400 and 500 may be performed by programmed computing devices. The blocks of the methods 400 and 500 may be executed based on instructions stored in a non-transitory computer readable medium, as will be readily understood. The non-transitory computer readable medium may include, for example, digital memories, magnetic storage media, such as magnetic disks and magnetic tapes, hard drives, or optically readable digital data storage media.

Referring to FIG. 4, at block 402, a request to access the capturing device 102 is generated by the OS 106 of the computing device 100. For example, the application 108 running on the OS 106 may generate the request to access the capturing device 102 to provide a functionality, such as audio conferencing or video conferencing.

At block 404, based on the request generated at block 402, an authentication parameter to authorize the request to access the capturing device 102 is obtained by the BIOS 110 of the computing device 100. As explained above, the authorization parameter may be a password, fingerprint, and random sequence of digits/characters.

At block 406, the obtained authentication parameter is verified by the BIOS 110. Based on a successful verification of the authentication parameter, the capturing device 102 is enabled by the BIOS. Upon enabling the capturing device, the application 108 may access the capturing device 102.

In an example, after the application 108 is allowed a session of access to the capturing device 102, for a duration that the session is ongoing, the BIOS 110 may continue to indicate to the user that the capturing device 102 is enabled. For instance, the indication may be a message displayed on the display 212 for the duration that the session is ongoing. In an example, the message may be displayed intermittently during the ongoing session. In an example, the indication may be an audio notification, such a ‘beep’ sound that may be generated by the BIOS 110 periodically during the ongoing session.

In an example, the BIOS 110 may also provide an option to disable the capturing device 102 during an ongoing session. In an example, the BIOS 110 may allow a capturing device 102 that was enabled at the start of the session to be disabled while the session may continue. For instance, a user may disable the camera 102-1 during a video call session and may continue the session as a voice call with the microphone 102-1 alone being enabled.

In an example implementation, the indication generated by the BIOS 110 to indicate that the capturing device 102 is enabled during a session, may present the user with the option to disable the capturing device 102. Accordingly, in an example implementation, the indication, when displayed as a message on the display 212, may provide a button that the user may activate, for example, using a mouse or a keyboard of the computing device 100 to disable the capturing device 102.

With the BIOS 110 providing an indication of a capturing device 102 being enabled during a session that had been authorized, situations where another session may be initiated by a malware application upon the user disabling the capturing device 102 during the session may be prevented. In an eventuality that the user disables the capturing device 102 during the session, yet the BIOS 110 continues to indicate that capturing device 102 is enabled, the user may be made aware of the capturing device 102 being used.

Referring to FIGS. 5A and 5B that illustrate a method 500 for authorizing access to the capturing device 102, according to an example implementation, at block 502, the BIOS 110 disables the access to the capturing device 102, by default. In other words, the capturing device 102 is disabled at all times except when being used by an application. As explained earlier, the BIOS 110 interfaces the input/output devices of the computing device 100 to the OS 106 during initialization of the OS 106 after a reset. The OS 106 may not be able to access an input/output device of the computing device 100, for example, the capturing device 102, if set to be disabled by the BIOS 110.

In an example, the BIOS 110 may disallow the OS 106 to access the capturing device 102, however, may indicate the capturing device 102 to be available to the OS 106, for example, by emulating the capturing device 102 that has been disabled to the OS 106.

At block 504, the application 108 running on the OS 106 of the computing device 100 may request access to the capturing device 102. The request is registered by the access detection module 208 of the OS 106 at block 506. In an example, the access detection module 208 may register a function call that the application 108 may make to the OS 106 to request access to the capturing device 102.

In an example implementation, as mentioned previously, the BIOS 110 may disable access of the capturing device 102 to the OS 106 and the capturing device 102 may not be visible to the OS 106. In such cases, in response the request to access to the capturing device 102, the OS 106 may generate a message indicative of the same. Accordingly, a message, such as ‘camera not found’ or ‘microphone disabled’ may be displayed on the display 212 of the computing device 100. In an example, such messages may not be displayed due to BIOS 110 emulating the capturing device 102 to the OS 106.

At block 508, the access detection module 208 notifies the BIOS 110 of the request to access to the capturing device 102. Based on the notification from the access detection module 208, at block 510, the BIOS 110 in turn notifies the user of the request. Example techniques of notifying the user include, but are not restricted to, generating an audio alert or a visual alert by the BIOS 110. Thus, the user is notified at every instance an application 108 requests access to the capturing device 102.

Referring now to FIG. 5B, at block 512, the BIOS 110 generates a prompt for obtaining the authentication parameter. As explained earlier, in an example, the authentication parameter may be a password or fingerprint. Thus, the prompt may request the user to enter the password or fingerprint. Also, in an example, the authentication parameter may be a BIOS-generated authentication parameter. Accordingly, in an example, generation of the prompt at block 512 may include generating and displaying the authentication parameter on the display device 212 of the computing device 100.

The authentication parameter is received by the BIOS 110 in response to the prompt, at block 514. Thereafter, at 516, the BIOS 110 verifies if the authentication parameter matches with an authorised authentication parameter. The authorised authentication parameter may be stored in the BIOS memory 204 and may not be readable by the OS 106. In an example, the authorised authentication parameter may be stored in the secure memory component 214.

If the determination made at block 516 is affirmative, the method 500 shifts to block 518, where the BIOS 110 enables the capturing device 102 such that the application 108 can access the capturing device 102. In an example, upon successful verification of the authentication parameter, the BIOS 110 may discontinue emulating the disabled capturing device 102 and allow the the OS 106 to communicate with capturing device 102 to enable the application 108 to access the capturing device 102.

Upon enabling the capturing device 102, the BIOS notifies the user, at block 520, that the access to the capturing device 102 has been allowed. The application 108 may initiate use of the capturing device 102 to capture image, video, or audio inputs once the capturing device 102 is enabled. After a session of use of the capturing device 102, the application 108 may end the session and terminate the access to the capturing device 102. For example, for a video conferencing application, the end of a video call may be the end of a session terminating the access of the camera 102-1 by the video conferencing application.

At block 522, the access detection module 208, registers the termination of the access to the capturing device 102 by the application 108. At block 524, the access detection module 208 notifies the BIOS 110 of the termination of the session. In an example, based on the notification by the access detection module 208, the BIOS 110 detects the termination of access to the capturing device 102 and accordingly, at block 526, generates a termination notification to notify the user of the termination of access. Thereafter, the method 500 again shifts to block 502, where the OS's 106 access to the capturing device 102 is disabled by the BIOS 110.

Detection of termination of access to the capturing device 102 by the application 108 triggers the BIOS 110 to disable the capturing device 102 upon the end of the session. This provides for avoiding situations where another session of access to the capturing device 102 may be initiated by a malware application at the end of the session by the application 108 that had authorized access to the capturing device 102.

Referring to block 516, if the determination made at block 516 is not affirmative, the method 500 shifts to block 528 where the BIOS 110 denies the request to access the capturing device 102 to the application 108. The BIOS 110, at block 530, may also notify the user that the request to access the capturing device 102 has been denied.

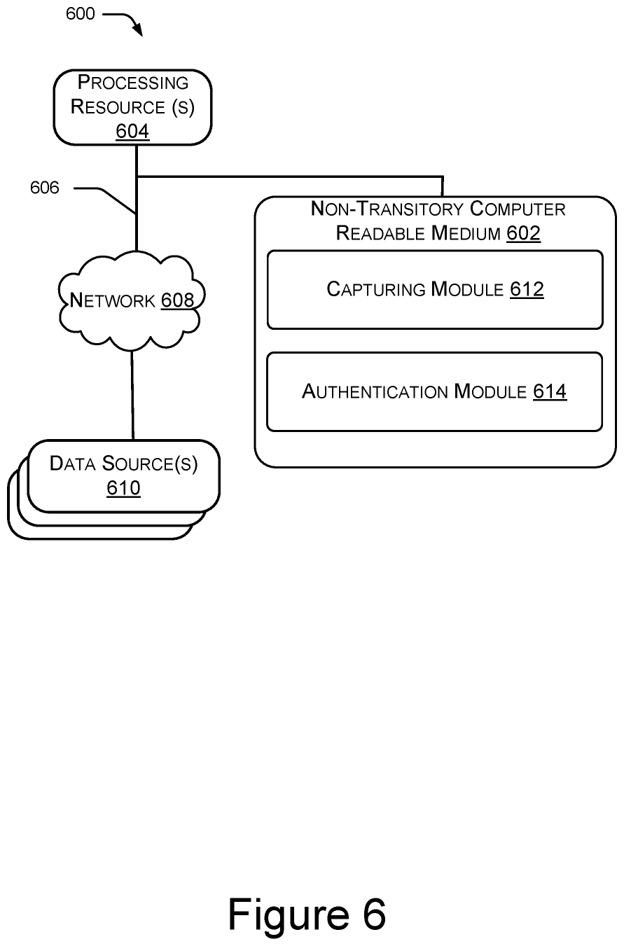

FIG. 6 illustrates a system environment 600 implementing a non-transitory computer-readable medium 602 for authorizing access to a capturing device of a computing device, according to an example of the present subject matter. In an example implementation, the system environment 600 may be a computing device having a capturing device, such as computing device 100 having the capturing device 102. The system environment 600 includes a processing resource 604 communicatively coupled to the non-transitory computer-readable medium 602 through a communication link 606. In an example, the processor resource 602 may be a processor of the computing device, such as the processor 104 of the computing device 100, that fetches and executes computer-readable instructions from the non-transitory computer-readable medium 602.

The non-transitory computer-readable medium 602 can be, for example, an internal memory device or an external memory device. In an example implementation, the communication link 606 may be a direct communication link, such as any memory read/write interface. In another example implementation, the communication link 606 may be an indirect communication link, such as a network interface. In such a case, the processing resource 604 can access the non-transitory computer-readable medium 602 through a network 608. The network 608 may be a single network or a combination of multiple networks and may use a variety of different communication protocols.

The processing resource 604 and the non-transitory computer-readable medium 602 may also be communicatively coupled to data sources 610. The data source(s) 610 may be used to store a BIOS of the computing device in an example. In an example implementation, the non-transitory computer-readable medium 602 includes a set of computer-readable instructions for authorizing the access to the capturing device of the computing device. The set of computer-readable instructions can be accessed by the processing resource 604 through the communication link 606 and subsequently executed to authorize the access to the capturing device.

In an example, the non-transitory computer-readable medium 602 may include a set of instructions implementing a capturing module 612 and an authentication module 614. The instructions implementing the capturing module 612 may, in one example, be a code executable to obtain an authentication parameter associated with a user of the computing device in response to a request to access the capturing device of the computing device from an application executing on the computing device. The instructions implementing the authentication module 614 may, in one example, be a code executable by the processing resource 604, to verify the authentication parameter based on an authorized authentication parameter stored in a secure memory component accessible to the BIOS of the computing device. Further, the code may be executable to enable the application to access the capturing device based on the verification.

In an example, the non-transitory computer-readable medium 602 may include a set of instructions that may, in one example, be executable by the by the processing resource 604 to generate a prompt to request the user to input the authentication parameter. Also, as mentioned before, in an example, the instructions cause the authentication parameter, received in response to the prompt, to be verified and cause the capturing device to be accessible by the application.

In an example, the non-transitory computer-readable medium 602 may also include a set of instructions implementing an authentication parameter generator (not shown). The instructions implementing the authentication parameter generator may, in one example, be executable code to generate the authentication parameter. The instructions may further be executable to display the authentication parameter on a display device of the computing device. The instructions may also be executable to receive and verify the authentication parameter and to enable the capturing device based on the verification.

Thus, the methods and systems of the present subject matter provide for authorizing access to a capturing device of a computing device. Although implementations of performing the authorization process have been described in a language specific to structural features and/or methods, it is to be understood that the appended claims are not necessarily limited to the specific features or methods described. Rather, the specific features and methods are disclosed as example implementations for communicating the system events.

We claim:

1. A method of authorizing access to a capturing device of a computing device, the method comprising:
generating, by an operating system (OS) of the computing device, a request to access the capturing device;
obtaining, by a basic input and output system (BIOS) of the computing device, an authentication parameter to authorize the request to access the capturing device;
verifying, by the BIOS, the authentication parameter; and
enabling, by the BIOS, the capturing device based on the verification.

2. The method as claimed in claim 1 further comprising, generating, by the BIOS, a notification to notify a user of the request to access the capturing device.

3. The method as claimed in claim 1, wherein obtaining further comprises:
generating a prompt, by the BIOS, for a user to input the authentication parameter; and
receiving, by the BIOS, the authentication parameter in response to the prompt.

4. The method as claimed in claim 3, wherein generating the prompt further comprises displaying the authentication parameter on a display device of the computing device.

5. The method as claimed in claim 1, wherein verifying comprises comparing the authentication parameter to an authorised authentication parameter stored in a secure memory component accessible to the BIOS.

6. The method as claimed in claim 1 further comprising:
detecting, by the BIOS, termination of access to the capturing device by the OS; and
generating, by the BIOS, a termination notification to notify a user of the termination of access.

7. A computing device comprising:
a capturing device comprising at least one of a camera and a microphone;
a processor to host an operating system (OS) of the computing device, the OS to execute an application; and
a basic input and output system (BIOS) associated with the processor, the BIOS comprising an authentication module to:
obtain an authentication parameter, in response to a request to access the capturing device from the application; and
enable the application to access the capturing device based on a verification of the authentication parameter.

8. The computing device as claimed in claim 7, wherein the BIOS comprises a notification module to:
receive the request to access the capturing device from the application; and
notify a user of the request to access the capturing device.

9. The computing device as claimed in claim 7, wherein the BIOS comprises a capturing module to capture the authentication parameter based on an input provided by a user.

10. The computing device as claimed in claim 9, wherein the capturing module comprises a fingerprint capturing module to capture a fingerprint of the user.

11. The computing device as claimed in claim 7, wherein the BIOS comprises an authentication parameter generator to generate the authentication parameter.

12. The computing device as claimed in claim 9, wherein, by default, the BIOS is to disable access of the capturing device by the OS.

13. A non-transitory computer-readable medium comprising instructions executable by a processing resource to:
obtain, in response to a request to access a capturing device of a computing device from an application executing on the computing device, an authentication parameter associated with a user of the computing device;
verify the authentication parameter based on an authorized authentication parameter stored in a secure memory component accessible to a basic input and output system (BIOS) of the computing device; and
enable the application to access the capturing device based on the verification.

14. The non-transitory computer-readable medium as claimed in claim 13, further comprising instructions executable by the processing resource to:
generate a prompt to request the user to input the authentication parameter; and
receive the authentication parameter in response to the prompt.

15. The non-transitory computer-readable medium as claimed in claim 13, further comprising instructions executable by the processing resource to:
generate the authentication parameter; and
display the authentication parameter on a display device of the computing device; and receive the authentication parameter in response to the display.
